(19) United States
(12) Patent Application Publication
(10) Pub. No.: US 2025/0058688 A1
(43) Pub. Date: Feb. 20, 2025

(54) ACTUATOR PUSH STRUCTURE WITH MASSAGING ELEMENTS

(71) Applicant: Toyota Motor Engineering & Manufacturing North America, Inc., Plano, TX (US)

(72) Inventors: Brian J. Pinkelman, Ann Arbor, MI (US); Michael Paul Rowe, Pinckney, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/452,376

(22) Filed: Aug. 18, 2023

(51) Int. Cl. B60N 2/90; B60N 2/02

(52) U.S. Cl. CPC B60N 2/976; B60N 2/026

(57) ABSTRACT

An actuator is configured to provide an enhanced haptic or massaging sensation to a user. The actuator can include an outer body member. The actuator can include a push structure operatively connected to the outer body member. The actuator can include a massaging element movably connected to the push structure. When activated, the actuator can be configured to morph into an activated configuration in which a dimension of the actuator increases and such that a position of the push structure changes. When the massaging element can be brought into operative contact with an object so as to cause a movement of the massaging element. As a result, the massaging element can move from a neutral position to a moved position.

### FIELD

The subject matter described herein relates in general to actuators and, more particularly, to actuators that provide a haptic effect.

### BACKGROUND

A vehicle typically includes a plurality of seats. There are numerous vehicle seat designs. Vehicles seats can be contoured and/or can include features to provide support and comfort to a vehicle occupant. Some vehicle seats can include various ergonomic features to enhance user comfort. Some vehicle seats are powered and allow a user to adjust one or more aspects of the seat. Some vehicle seats can provide a massaging effect to a user.

### SUMMARY

In one respect, the present disclosure is directed to an actuator. The actuator can include an outer body member. The actuator can include a push structure operatively connected to the outer body member. The actuator can include a massaging element movably connected to the push structure. When activated, the actuator can be configured to morph into an activated configuration in which a dimension of the actuator increases and such that a position of the push structure changes.

In another respect, the present disclosure is directed to a method for an actuator. The actuator can include an outer body member. The actuator can include a push structure operatively connected to the outer body member. The actuator can include a massaging element movably connected to the push structure. The method can include causing the actuator to morph into an activated configuration in which a dimension of the actuator increases and such that a position of the push structure changes. The method can include bringing the massaging element into operative contact with an object so as to cause a movement of the massaging element. As a result, the massaging element can move from a neutral position to a moved position.

### BRIEF DESCRIPTION OF THE DRAWINGS

FIG. 1 is a cross-sectional view of an example of an actuator, showing a non-activated configuration.

FIG. 2 is a cross-sectional view of the actuator of FIG. 1, showing an activated configuration.

FIG. 3 is an example of a massaging element, showing a neutral position.

FIG. 4 is an example of the massaging element of FIG. 3, showing a moved position.

FIG. 5 is an example of a system for an actuator.

FIG. 6 is an example of a method of actuating an actuator.

### DETAILED DESCRIPTION

Vehicle seats that provide a haptic effect, such as massaging, typically do not offer much flexibility in the haptic output. Accordingly, arrangements described herein are directed to, among other things, an actuator. The actuator can include a push structure. One or more massaging elements movably connected to the push structure. When activated, the actuator can be configured to morph into an activated configuration in which a dimension of the actuator increases and such that a position of the push structure changes. The massaging element(s) can move with the push structure. When the massaging element(s) on the push structure come into contact with a surface, the massaging elements can move, thereby provided a massaging effect in additional to the effect of the pushing effect of the push structure. As a result, an enhanced haptic effect and/or enhanced massaging can be provided by the actuator.

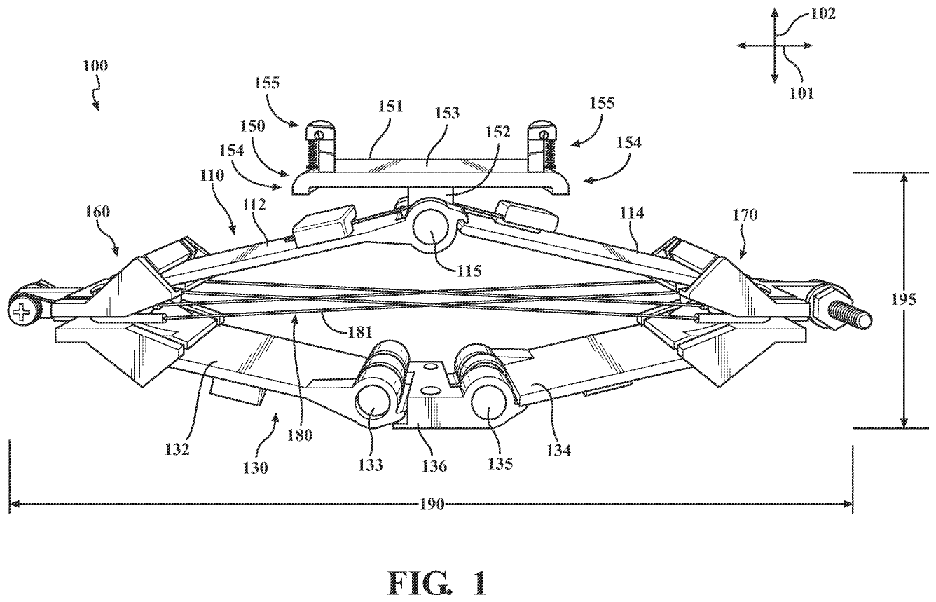

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

Arrangements described herein are directed to an actuator. The actuator can be any suitable type of actuator, now known or later developed. Therefore, it will be understood that the examples described herein are not intended to be limiting.

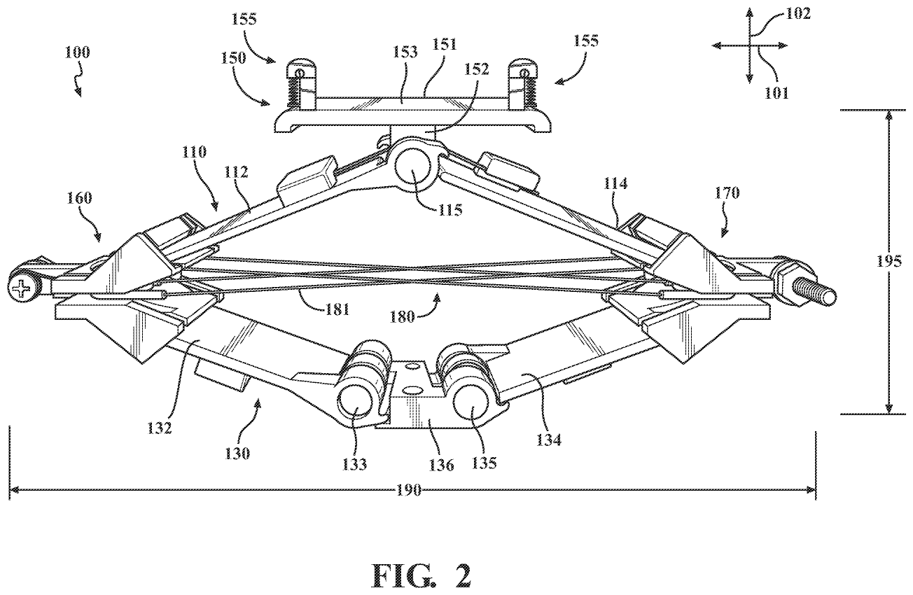

Referring to FIGS. 1 and 2, an example of an actuator 100 suitable for use according to arrangements herein. The basic details of the actuator 100 will now be described. Additional details of the actuator 100 are described in U.S. patent application Ser. No. 18/329,217, which is incorporated herein by reference.

The actuator 100 can include a first outer body member 110, a second outer body member 130, a first endcap 160, a second endcap 170, and a contracting member 180. The first endcap 160 and the second endcap 170 can be spaced apart in a first direction 101. The first outer body member 110 and the second outer body member 130 can be spaced apart in a second direction 102.

The first outer body member 110 can include a first portion 112 and a second portion 114. The first portion 112 and the second portion 114 can be operatively connected to each other such that the first portion 112 and the second portion 114 can move relative to each other. In one or more arrangements, the first portion 112 and the second portion 114 can be pivotably connected to each other. For example, the first portion 112 and the second portion 114 can be pivotably connected to each other by one or more hinges 115. The first portion 112 and the second portion 114 can be angled relative to each other. As a result, the first outer body member 110 can have a generally V-shape.

The second outer body member 130 can include a first portion 132, a second portion 134, and a base 136. In one or more arrangements, each of the first portion 132 and the second portion 134 can be pivotably connected to the base 136. For example, the first portion 132 can be pivotably connected to the base 136 by one or more hinges 133, and the second portion 134 can be pivotably connected to the base 136 by one or more hinges 135. The first portion 132 and the second portion 134 can be located on opposite sides of the base 136.

As noted above, the actuator 100 can include a first endcap 160 and a second endcap 170. The first endcap 160 and the second endcap 170 can have any suitable size, shape, and/or configuration. In one or more arrangements, the first endcap 160 and the second endcap 170 can be substantially identical to each other. In one or more arrangements, the first endcap 160 and the second endcap 170 can be different from each other in one or more respect.

The actuator 100 can include one or more contracting members 180. The contracting member(s) 180 can be any structure that, when activated, is configured to shrink in length. In one or more arrangements, the contracting member(s) 180 can be one or more shape memory material members 181. The shape memory material member(s) 181 can extend between the first endcap 160 and the second endcap 170 in any suitable manner. The shape memory material member(s) 181 can be operatively connected to the first endcap 160 and the second endcap 170. Any suitable manner of operative connection can be provided, such as one or more fasteners, one or more adhesives, one or more welds, one or more brazes, one or more forms of mechanical engagement, or any combination thereof.

In some arrangements, there can be a single shape memory material member 181. In such case, the shape memory material member 181 can, for example, extend straight across the cavity from the first endcap 160 and the second endcap 170. In another example, the shape memory material member 181 can extend in a serpentine pattern between the first endcap 160 and the second endcap 170. In some arrangements, the first endcap 160 and the second endcap 170 can be configured to allow the shape memory material member 181 to turn around and extend in the opposite direction, as described above.

In some arrangements, there can be a plurality of shape memory material members 181. In such case, the plurality of shape memory material members 181 can be distributed, arranged, and/or oriented in any suitable manner. For instance, the shape memory material members 181 can extend substantially parallel to each other. In other arrangements, one or more of the shape memory material members 181 can extend non-parallel to the other shape memory material members 181. In some instances, some of the plurality of shape memory material members 181 may cross over each other.

The phrase “shape memory material” includes materials that changes shape when an activation input is provided to the shape memory material and, when the activation input is discontinued, the material substantially returns to its original shape. Examples of shape memory materials include shape memory alloys (SMA) and shape memory polymers (SMP).

In one or more arrangements, the shape memory material members 181 can be shape memory material wires. As an example, the shape memory material members 181 can be shape memory alloy wires. Thus, when an activation input (i.e., heat) is provided to the shape memory alloy wire(s), the wire(s) can contract. Shape memory alloy wire(s) can be heated in any suitable manner, now known or later developed. For instance, shape memory alloy wire(s) can be heated by the Joule effect by passing electrical current through the wires. In some instances, arrangements can provide for cooling of the shape memory alloy wire(s), if desired, to facilitate the return of the wire(s) to a non-activated configuration.

The wire(s) can have any suitable characteristics. For instance, the wire(s) can be high temperature wires with austenite finish temperatures from about 80 degrees Celsius to about 110 degrees Celsius. The wire(s) can have any suitable diameter. For instance, the wire(s) can be from about 0.2 millimeters (mm) to about 0.7 mm, from about 0.3 mm to about 0.5 mm, or from about 0.375 millimeters to about 0.5 millimeters in diameter. In some arrangements, the wire(s) can have a stiffness of up to about 70 gigapascals. The pulling force of SMA wire(s) can be from about 150 MPA to about 400 MPa. The wire(s) can be configured to provide an initial moment of from about 300 to about 600 N·mm, or greater than about 500 N·mm, where the unit of newton millimeter (N·mm) is a unit of torque (also called moment) in the SI system. One newton meter is equal to the torque resulting from a force of one newton applied perpendicularly to the end of a moment arm that is one meter long. In various aspects, the wire(s) can be configured to transform in phase, causing the shape memory material members 181 to be moved from non-activated position to an activated position in about 3 seconds or less, about 2 seconds or less, about 1 second or less, or about 0.5 second or less.

The wire(s) can be made of any suitable shape memory material, now known or later developed. Different materials can be used to achieve various balances, characteristics, properties, and/or qualities. As an example, an SMA wire can include nickel-titanium (Ni—Ti, or nitinol). One example of a nickel-titanium shape memory alloy is FLEXINOL, which is available from Dynaolloy, Inc., Irvine, California. As a further example, the SMA wires can be made of Cu—Al—Ni, Fe—Mn—Si, or Cu—Zn—Al.

The SMA wire can be configured to increase or decrease in length upon changing phase, for example, by being heated to a phase transition temperature T_{SMA}. Utilization of the intrinsic property of SMA wires can be accomplished by using heat, for example, via the passing of an electric current through the SMA wire in order provide heat generated by electrical resistance, in order to change a phase or crystal structure transformation (i.e., twinned martensite, detwinned martensite, and austenite) resulting in a lengthening or shortening the SMA wire. In some implementations, during the phase change, the SMA wire can experience a decrease in length of from about 2 to about 8 percent, or from about 3 percent to about 6 percent, and in certain aspects, about 3.5 percent, when heated from a temperature less than the T_{SMA} to a temperature greater than the T_{SMA}.

Other active materials may be used in connection with the arrangements described herein. For example, other shape memory materials may be employed. Shape memory materials, a class of active materials, also sometimes referred to as smart materials, include materials or compositions that have the ability to remember their original shape, which can subsequently be recalled by applying an external stimulus, such as an activation signal.

While the shape memory material member(s) 181 are described, in some implementations, as being wires, it will be understood that the shape memory material member(s) 181 are not limited to being wires. Indeed, it is envisioned that suitable shape memory materials may be employed in a variety of other forms, such as sheets, plates, panels, strips, cables, tubes, or combinations thereof. In some arrangements, the shape memory material member(s) 181 may include an insulating coating or an insulating sleeve over at least a portion of their length.

It should be noted that the shape memory material member(s) 181 can be located substantially entirely within the overall envelope of the actuator 100. A portion of the shape memory material member(s) 181 can extend outside of a respective one of the endcaps 160, 170 for operative connection to another conductor and/or power source.

The actuator 100 can include a first dimension 190, which can correspond to the first direction 101. The actuator 100 can include a second dimension 195, which can correspond to the second direction 102. The first dimension 190 can describe a width of the actuator 100, and the second dimension 195 can describe a height of the actuator 100. The first dimension 190 and the second dimension 195 can be substantially perpendicular to each other.

FIG. 1 shows an example of the actuator 100 in a non-activated configuration. Here, the shape memory material member(s) 181 are not activated. FIG. 2 shows an example of the actuator 100 in an activated configuration. When an activation input (e.g., electrical energy or other input that can change the temperature of the shape memory material member(s) 181) is provided to the shape memory material member(s) 181, the shape memory material member(s) 181 can contract. This contraction can cause the actuator 100 to morph into the activated configuration. More particularly, the contraction can cause the shape memory material member(s) 181 to pull the first endcap 160 and the second endcap 170 toward each other in the first direction 101. As a result, the first outer body member 110 and the second outer body member 130 can extend outward and away from each other in a direction that corresponds to the second direction 102. It will be appreciated that, in going from the non-activated condition to the activated condition, the first dimension 190 (i.e., the width) of the actuator 100 can decrease and/or the second dimension 195 (i.e., the height) of the actuator 100 can increase. Further, it will be appreciated that the actuator 100 can deliver a force in a direction that is out of plane or otherwise different from the direction of contraction of the shape memory material member(s) 181.

Again, the actuator 100 shown in FIGS. 1-2 is merely one example of a suitable actuator in accordance with arrangements described herein and is not intended to be limiting. Other actuators are described in U.S. patent publication Ser. Nos. 17/729,522 and 18/329,217 as well as U.S. Pat. Nos. 10,960,793, which are incorporated herein by reference in their entireties. Further, it will be appreciated that arrangements described herein are not limited to actuators with contracting member(s) or shape memory material member(s).

The actuator 100 can include a push structure 150. The push structure 150 can be configured to engage other structures, surfaces, or objects. The push structure 150 can focus the force of the actuator 100 on an intended target object. The push structure 150 can have any suitable size, shape, and/or configuration. In one or more arrangements, the push structure 150 can be substantially T-shaped. In some arrangements, the push structure 150 can include a platform 151 and a stem 152. In some arrangements, the platform 151 can substantially be a rectangular prism, as is shown. In some instances, the platform 151 can have downturned ends 154, as shown. In some instances, the platform 151 can be a plate-like structure. In other arrangements, the platform 151 can be substantially cylindrical, substantially elliptical cylindrical, substantially triangular prismatic, substantially polygonal prismatic, substantially hexagonal prismatic, substantially octagonal prismatic, substantially trapezoidal prismatic, substantially barrel-shaped, or substantially half-barrel shaped, just to name a few possibilities.

The platform 151 can have an engaging surface 153. The engaging surface 153 can be configured to provide a desired actuation effect on an intended target. In some arrangements, the engaging surface 153 can be substantially planar. In some arrangements, the engaging surface 153 can include one or more contours, protrusions, steps, recesses, elements, or other raised or non-planar features. The engaging surface 153 can be configured to create a focal point for the push force of the actuator 100. In some arrangements, the engaging surface 153 can include textures to provide an additional sensation. In some arrangements, the engaging surface 153 can include at least partially embedded rollers or other features to provide an additional sensation.

The engaging surface 153 can have any suitable size, shape, and/or configuration. For instance, the engaging surface 153 can be substantially rectangular, substantially circular, substantially oval, substantially polygonal, substantially triangular, substantially hexagonal, substantially octagonal, or substantially trapezoidal, just to name a few possibilities.

In some arrangements, the engaging surface 153 can be substantially parallel to the shape memory material member(s) 181 and/or to the first direction 101 of the actuator 100. In some arrangements, the engaging surface 153 can be angled relative to the shape memory material member(s) 181/contracting member(s) 180 and/or to the first direction 101 of the actuator 100. The engaging surface 153 can have any suitable orientation to achieve a desired actuation force effect.

The push structure 150 can be operatively connected to the first outer body member 110. In some arrangements, the push structure 150 can be operatively connected to the first portion 112 and the second portion 114. While the first portion 112 and the second portion 114 can pivot relative to each other, the push structure 150 can substantially maintain its orientation. In some arrangements, the push structure 150 can be substantially centrally located on the first outer body member 110. However, in other arrangements, the push structure 150 can be offset from the center of the first outer body member 110. In some arrangements, the actuator 100 can be a plurality of push structures 150.

When the actuator 100 morphs into the activated configuration, the position of the push structure 150 can change. For instance, in the orientation of the actuator 100 shown in FIGS. 1-2, the push structure 150 move to a higher elevation when the actuator 100 morphs from the non-activated configuration to the activated configuration.

One or more massaging elements 155 can be operatively connected to the push structure 150 such that the one or more massaging elements 155 are movable thereon. In one or more arrangements, the one or more massaging elements 155 can be operatively connected to the platform 151. The one or more massaging elements 155 can be configured such that, when the one or more massaging elements 155 come into contact with a surface or object, the one or more massaging elements 155 can move.

There can be any suitable number of massaging elements 155 on the push structure. For instance, in one or more arrangements, there can be a single massaging element 155 operatively connected to the push structure 150. In such case, the single massaging element 155 can be provided in any suitable location on the push structure 150. For instance, the single massaging element 155 can be substantially centrally located on the push structure 150. Alternatively, the single massaging element 155 can be located at or near one of the sides, edges, or corners of the push structure 150. In some instances, the single massaging element 155 can be substantially the same size as the engaging surface 153 of the push structure 150.

In some instances, there can be a plurality of massaging elements 155 operatively connected to the push structure 150. In some instances, the plurality of massaging elements 155 can be substantially identical to each other. Alternatively, one or more of the plurality of massaging elements 155 can be different from the other massaging elements 155 in one or more respects, such as size, shape, configuration, movement, massaging effect, etc.

In such cases, the plurality of massaging elements 155 can be distributed on the push structure 150 in any suitable manner. For instance, the plurality of massaging elements 155 can be located adjacent to each other. Alternatively, the plurality of massaging elements 155 can be spaced apart. In some arrangements, the plurality of massaging elements 155 can be located on opposite sides of the push structure, as is shown as a non-limiting example in FIGS. 1 and 2. In other arrangements, the plurality of massaging elements 155 can be distributed near the sides or edges of the push structure 150 so as to extend substantially about the perimeter of the engaging surface 153. In other arrangements, the plurality of massaging elements 155 can be located along one or more sides of the engaging surface 153. In some arrangements, the plurality of massaging elements 155 can be centrally located on the push structure 150.

In some instances, at least some of the plurality of massaging elements 155 can be arranged in alignment with each other. For instance, a plurality of the massaging elements 155 can be arranged in rows and/or columns on the push structure 150. In some instances, the plurality of massaging elements 155 can be arranged in a plurality of discrete areas, which may or may not be spaced apart, on the push structure 150. In some arrangements, the plurality of massaging elements 155 can be distributed so as to substantially cover a portion of, a majority of, or the entirety of the engaging surface 153 of the push structure 150.

In some arrangements, the plurality of massaging elements 155 can be arranged so as to be substantially aligned with each other, as is shown in FIGS. 1 and 2. However, in other arrangements, one or more of the plurality of massaging elements 155 can be offset from the other massaging elements 155 in one or more directions. In some instances, the massaging elements 155 can be raised from the engaging surface 153 at different lengths.

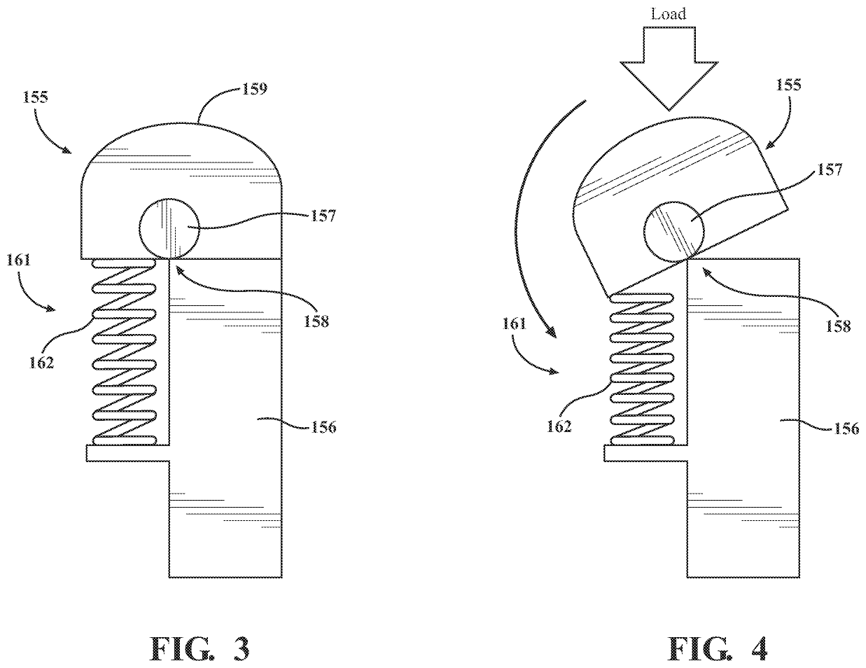

As noted above, the massaging element(s) 155 can be operatively connected to the push structure 150 so as to be movable thereon. There are various ways in which such a relationship can be achieved. One example is shown in FIGS. 3-4. In this example, the massaging element(s) 155 can be movably connected to a post 156. The post 156 can be operatively connected to the push structure 150. In some instances, the post 156 can be formed with the push structure 150 as a unitary structure. Alternatively, the post 156 can be formed separately from the push structure 150 and attached thereto by, for example, one or more welds, one or more brazes, one or more adhesives, one or more forms of mechanical engagement, any other form of attachment, or any combination thereof.

The post 156 can extend away from the push structure 150. For instance, the post 156 can extend away from the engaging surface 153 of the push structure 150. The post 156 can extend at any suitable angle relative to the push structure 150. In one or more arrangements, the post 156 can extend at substantially 90 degrees relative to the engaging surface 153 of the push structure 150. However, in other arrangements, the post 156 can extend at more than 90 degrees relative to the engaging surface 153 of the push structure 150. In still other arrangements, the post 156 can extend at less than 90 degrees relative to the engaging surface 153 of the push structure 150. The post 156 can be substantially straight. Alternatively, the post 156 can include one or more non-straight features, such as bends, curves, steps, etc. The post 156 can have any suitable cross-sectional shape, including rectangular, circular, polygonal, triangular, or any other suitable shape.

The massaging element(s) 155 can be movably connected to the post 156 in any suitable manner. For instance, the massaging element(s) 155 can be movably connected to the post 156 by one or more hinges 157. As a result, the massaging element(s) 155 can pivot relative to the post 156 and/or about an axis. In some instances, the massaging element(s) 155 can be configured to rotate about an axis.

The massaging element(s) 155 can be operatively connected to an end of the post 156. A portion of the massaging element(s) 155 can extend over a corner or an edge 158 of the post 156.

The massaging element(s) 155 can have any suitable size, shape or configuration. In one or more arrangements, the massaging element(s) 155 can be substantially spherical, substantially semi-spherical, substantially spherical, substantially barrel-like, substantially half-barrel like, substantially semi-elliptical, or substantially torispherical, just to name a few possibilities. The massaging element(s) 155 can include a surface for engaging with an object, such as a person. In some arrangements, the surface 159 can be smooth. In some arrangements, the surface 159 does not include any corners or sharp edges. In some arrangements, the surface 159 can include textures, non-smooth features (e.g., protrusions, bumps, contours, etc.), or other features to provide an additional sensation. The massaging element(s) 155 can be made of any suitable material, such as metal or plastic.

In some arrangements, the massaging element(s) 155 can be partially embedded in the push structure 150. In such case, a portion of the massaging element(s) 155 can extend beyond the engaging surface 153 of the push structure 150. The push structure 150 can include a recess into which the massaging element(s) 155 is partially received.

In one or more implementations, the massaging element(s) 155 can be rollers. In one or more arrangements, the rollers the can be partially embedded in the push structure 150, such that a portion of the roller is located within the thickness of the platform 151 and another portion of the roller protrudes beyond the engaging surface 153 of the push structure 150. The roller can rotate about an axis.

The massaging element(s) 155 can be configured to move when a load is imparted thereon. More particularly, in the example arrangement shown, the massaging element(s) 155 can be configured to pivot on the post(s) 156 when a load in imparted on the massaging element(s) 155. Such imparting of a load on the massaging element(s) 155 can occur when the actuator 100 is activated and causes the push structure 150 and the massaging element(s) 155 to move. For instance, the push structure 150 and the massaging element(s) 155 can move toward a surface or an object. The massaging element(s) 155 can operatively contact the surface or object. As a load is imposed on the massaging element(s) 155 due to the contact and/or further contact, the massaging element(s) 155 can move, such as by pivoting or rotating. As a result, the massaging element(s) 155 can move from a neutral position (FIG. 3) to a moved position (FIG. 4). The movement of the massaging element(s) 155 can be felt by a person and can provide a further massaging sensation in addition to a pushing sensation provided by the push structure 150. “Operatively contact” includes direct contact or indirect contact. For instance, if the actuator 100 is located within a seat, the massaging element(s) 155 can indirectly contact a person sitting in the seat through any material of the seat itself and/or any clothing worn by the person.

There can be one or more biasing elements 161 operatively associated with the massaging element(s) 155. The biasing element(s) 161 can bias the massaging element(s) 155 toward the neural position. The biasing element(s) 161 can be any suitable structure, such a spring 162. The spring 162 can be any suitable type of spring, now known or later developed.

In one example, the actuator 100 can be used in connection with a vehicle seat. When the actuator 100 is activated, the push structure 150 and the massaging element(s) 155 can move toward a person seated in the vehicle seat. The massaging element(s) 155 can come into operative contact with the back or other body portion. When such operative contact occurs, the massaging element(s) 155 can move. As a result, the person not only feels the pushing effect of the actuator 100 but also the movement of the massaging element(s) 155, thereby providing an enhanced massaging or haptic effect. If the person moves his or her back forward or if a person leaves the seat, it can reduce or even eliminate the load imposed on the massaging element(s) 155. As a result, the massaging element(s) 155 can return to the neutral position under the force of the biasing element(s) 161.

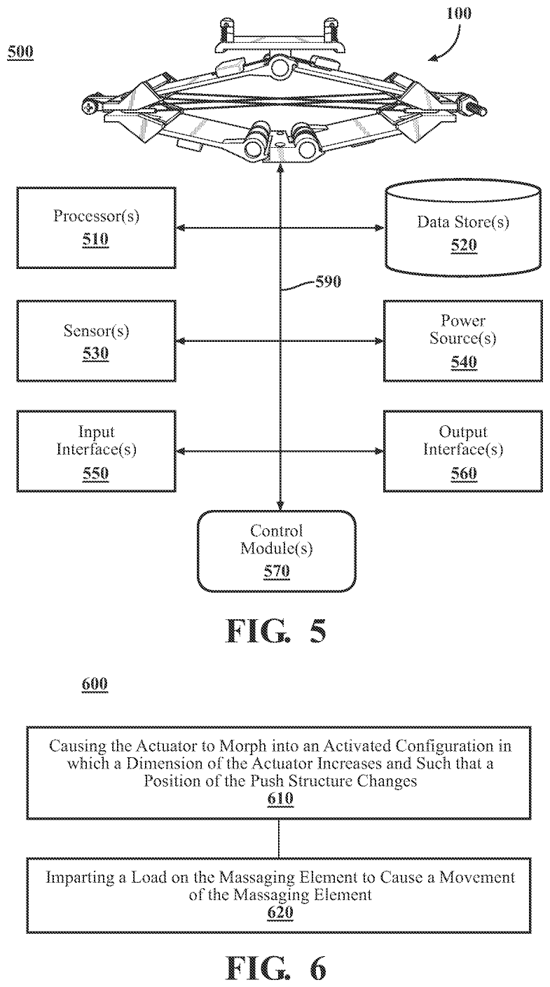

Referring to FIG. 5, an example of a system 500 for the actuator 100 with the massaging element(s) 155. The system 500 can include various elements. Some of the possible elements of the system 500 are shown in FIG. 5 and will now be described. It will be understood that it is not necessary for the system 500 to have all of the elements shown in FIG. 5 or described herein. The system 500 can have any combination of the various elements shown in FIG. 5. Further, the system 500 can have additional elements to those shown in FIG. 5. In some arrangements, the system 500 may not include one or more of the elements shown in FIG. 5. Further, the elements shown may be physically separated by large distances. Indeed, one or more of the elements can be located remotely from the other elements of the system 500, such an on a remote server or cloud-based server.

In some arrangements, various elements of the system 500 may be located on or within a vehicle, it will be understood that one or more of these elements can be located external to the vehicle. Thus, such elements are not located on, within, or otherwise carried by the vehicle. In some arrangements, one or more elements of the system 500 can be located on or within a seat.

The system 500 can include one or more processors 510, one or more data stores 520, one or more sensors 530, one or more power sources 540, one or more input interfaces 550, one or more output interfaces 560, and/or one or more control modules 570. Each of these elements will be described in turn below.

As noted above, the system 500 can include one or more processors 510. “Processor” means any component or group of components that are configured to execute any of the processes described herein or any form of instructions to carry out such processes or cause such processes to be performed. The processor(s) 510 may be implemented with one or more general-purpose and/or one or more special-purpose processors. Examples of suitable processors include microprocessors, microcontrollers, DSP processors, and other circuitry that can execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The processor(s) 510 can include at least one hardware circuit (e.g., an integrated circuit) configured to carry out instructions contained in program code. In arrangements in which there is a plurality of processors 510, such processors can work independently from each other or one or more processors can work in combination with each other.

The system 500 can include one or more data stores 520 for storing one or more types of data. The data store(s) 520 can include volatile and/or non-volatile memory. Examples of suitable data stores 520 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 520 can be a component of the processor(s) 510, or the data store(s) 520 can be operatively connected to the processor(s) 510 for use thereby. The term “operatively connected,” as used throughout this description, can include direct or indirect connections, including connections without direct physical contact.

In some arrangements, the data store(s) 520 can store one or more actuation profiles. The actuation profiles can include instructions for activating one or more of the actuator 100 in a specified manner. The actuation profiles can include activation patterns, activation sequences, activation zones, activation regions, activation times, activation of individual actuator or groups of actuator, etc. The actuation profiles can be created by an end user, a seat manufacturer, a vehicle manufacturer, or some other entity. In some instances, one or more actuation profiles can be received from a remote source.

The system 500 can include one or more sensors 530. “Sensor” means any device, component and/or system that can detect, determine, assess, monitor, measure, quantify, acquire, and/or sense something. The one or more sensors can detect, determine, assess, monitor, measure, quantify, acquire, and/or sense in real-time. As used herein, the term “real-time” means a level of processing responsiveness that a user or system senses as sufficiently immediate for a particular process or determination to be made, or that enables the processor to keep up with some external process.

In arrangements in which the system 500 includes a plurality of sensors 530, the sensors can work independently from each other. Alternatively, two or more of the sensors can work in combination with each other. In such case, the two or more sensors can form a sensor network. The sensor(s) 530 can be operatively connected to the processor(s) 210, the data store(s) 520, and/or other elements of the system 500 (including any of the elements shown in FIG. 1). The sensor(s) 530 can include any suitable type of sensor, now known or later developed. For instance, when the system 500 is used in connection with a seat, the sensor(s) 530 can include one or more seat occupant sensors. The seat occupant sensor(s) can include one or more weight sensors, position sensors, proximity sensors, contact sensors, or any other sensor, now known or later developed, that can acquire data or information about a seat occupant or the seat relative to the seat occupant.

As noted above, the system 500 can include one or more power sources 540. The power source(s) 540 can be any power source capable of and/or configured to energize the actuator 100, as will be described later. For example, the power source(s) 540 can include one or more batteries, one or more fuel cells, one or more generators, one or more alternators, one or more solar cells, and combinations thereof. The power source(s) 540 can be any suitable source of electrical energy.

The system 500 can include one or more input interfaces 550. An “input interface” includes any device, component, system, element or arrangement or groups thereof that enable information/data to be entered into a machine. The input interface(s) 550 can receive an input from a vehicle occupant (e.g. a driver or a passenger). Any suitable input interface 550 can be used, including, for example, a keypad, gesture recognition interface, voice recognition interface, display, touch screen, multi-touch screen, button, joystick, mouse, trackball, microphone and/or combinations thereof.

The system 500 can include one or more output interfaces 560. An “output interface” includes any device, component, system, element or arrangement or groups thereof that enable information/data to be presented to a vehicle occupant (e.g. a person, a vehicle occupant, etc.). The output interface(s) 560 can present information/data to a vehicle occupant. The output interface(s) 560 can include a display. Alternatively or in addition, the output interface(s) 560 may include an earphone and/or speaker. Some components of the system 500 may serve as both a component of the input interface(s) 650 and a component of the output interface(s) 560.

The system 500 can include one or more modules, at least some of which will be described herein. The modules can be implemented as computer readable program code that, when executed by a processor, implements one or more of the various processes described herein. One or more of the modules can be a component of the processor(s) 510, or one or more of the modules can be executed on and/or distributed among other processing systems to which the processor(s) 510 is operatively connected. The modules can include instructions (e.g., program logic) executable by one or more processor(s) 210. Alternatively or in addition, one or more data stores 520 may contain such instructions. In some arrangements, the module(s) can be located remote from the other elements of the system 500.

In one or more arrangements, the modules described herein can include artificial or computational intelligence elements, e.g., neural network, fuzzy logic or other machine learning algorithms. Further, in one or more arrangements, the modules can be distributed among a plurality of modules. In one or more arrangements, two or more of the modules described herein can be combined into a single module.

The system 500 can include one or more control modules 570. The control module(s) 570 can include profiles and logic for controlling the actuator 100 or a plurality of the actuators 100. The control module(s) 570 can use profiles, parameters, or settings loaded into the control module(s) 570 and/or stored in the data store(s) 520, such as the actuation profiles. In some arrangements, the control module(s) 570 can be located remotely from the other elements of the system 500, such as on a remote server, a cloud-based server, or an edge server.

The control module(s) 570 can be configured to cause the actuator 100 to be activated or deactivated. As used herein, “cause” or “causing” means to make, force, compel, direct, command, instruct, and/or enable an event or action to occur or at least be in a state where such event or action may occur, either in a direct or indirect manner. For instance, the control module(s) 570 can cause the actuator 100 to be selectively activated or deactivated in any suitable manner. For instance, when the actuator 100 includes a shape memory material member, the shape memory material member can be heated by the Joule effect by passing electrical current through the shape memory material members. To that end, the control module(s) 570 can be configured to selectively permit, restrict, adjust, alter, and/or prevent the flow of electrical energy from the power source(s) 540 to the one or more shape memory material members of the actuator 100. The control module(s) 570 can be configured to send control signals or commands over the communication network 590 to the shape memory material members or to other elements of the system 500.

The control module(s) 570 can be configured to cause the actuator 100 to be activated or deactivated based on various events, conditions, inputs, or other factors. For instance, the control module(s) 570 can be configured to cause the actuator 100 to be activated or deactivated based on a user input. A user can provide an input on the input interface(s) 550. The input can be a command to activate the actuator 100.

In some arrangements, the control module(s) 570 can be configured to determine an appropriate action for the actuator 100 and/or the push structure 150. The control module(s) 570 can be configured to do so in any suitable manner. For instance, the control module(s) 570 can analyze data or information acquired by the sensor(s) 530 (e.g., the seat occupant sensor(s)) to detect when to activate the actuator 100.

The various elements of the system 500 can be communicatively linked to one another or one or more other elements through one or more communication networks 590. As used herein, the term “communicatively linked” can include direct or indirect connections through a communication channel, bus, pathway or another component or system. A “communication network” means one or more components designed to transmit and/or receive information from one source to another. The data store(s) 520 and/or one or more other elements of the system 500 can include and/or execute suitable communication software, which enables the various elements to communicate with each other through the communication network and perform the functions disclosed herein.

The one or more communication networks 590 can be implemented as, or include, without limitation, a wide area network (WAN), a local area network (LAN), the Public Switched Telephone Network (PSTN), a wireless network, a mobile network, a Virtual Private Network (VPN), the Internet, a hardwired communication bus, and/or one or more intranets. The communication network further can be implemented as or include one or more wireless networks, whether short range (e.g., a local wireless network built using a Bluetooth or one of the IEEE 802 wireless communication protocols, e.g., 802.11a/b/g/i, 802.15, 802.16, 802.20, Wi-Fi Protected Access (WPA), or WPA2) or long range (e.g., a mobile, cellular, and/or satellite-based wireless network; GSM, TDMA, CDMA, WCDMA networks or the like). The communication network can include wired communication links and/or wireless communication links. The communication network can include any combination of the above networks and/or other types of networks.

Now that the various potential systems, devices, elements and/or components of the actuator 100 and the system 500 have been described, various methods will now be described. Various possible steps of such methods will now be described. The methods described may be applicable to the arrangements described above, but it is understood that the methods can be carried out with other suitable systems and arrangements. Moreover, the methods may include other steps that are not shown here, and in fact, the methods are not limited to including every step shown. The blocks that are illustrated here as part of the methods are not limited to the particular chronological order. Indeed, some of the blocks may be performed in a different order than what is shown and/or at least some of the blocks shown can occur simultaneously.

Turning to FIG. 6, an example of a method 600 of actuating an actuator with one or more massaging elements is shown. At block 610, the actuator 100 can be caused to morph into an activated configuration in which a dimension of the actuator 100 increases and such that a position of the push structure 150 changes. Such causing can be performed by the processor(s) 510 and/or the control module(s) 570. For instance, the processor(s) 510 and/or the control module(s) 570 can cause or allow the flow of electrical energy from the power sources(s) 540 to the actuator 100. In a particular example, the processor(s) 510 and/or the control module(s) 570 can cause or allow the flow of electrical energy from the power sources(s) 540 to the contracting member(s) 180 or the shape memory material member(s) 181 of the actuator 100. The dimension that increases can be the second dimension 195 (e.g., the height). The causing can be performed responsive to a user input received on the input interface(s) 550 and/or based on sensor data acquired by the sensor(s) 530. The method 600 can continue to block 620.

At block 620, a load can be imparted on the massaging element 155 to cause a movement of the massaging element 155. As a result, the massaging element 155 can move from a neutral position to a moved position. Imparting a load on the massaging element 155 can include bringing the massaging element 155 into operative contact with an object (e.g., a person) so as to cause a movement of the massaging element 155. Bringing the massaging element 155 into operative contact with the object can occur as the position of the massaging element 155 changes when the actuator 100 moves into the activated configuration.

The method 600 can end. Alternatively, the method 600 can return to block 610 or to some other block. The method 600 can be repeated at any suitable point, such as at a suitable time or upon the occurrence of any suitable event or condition.

Arrangements described herein can be used in various applications. For instance, arrangements described herein can be used in connection with a seat. In such a case, one or more of the actuators 100 can be located within or operatively positioned relative to a seat. The seat can be any type of vehicle seat, now known or later developed. In one or more arrangements, the seat can be a vehicle seat. “Vehicle” means any form of transport, including motorized or powered transport. In one or more implementations, the vehicle can be an automobile, a watercraft, an aircraft, a hovercraft, a spacecraft, or any other form of transport. In other arrangements, the seat can be an office chair, a chair, a massage chair, a gaming chair, a recliner, or any other seat structure, now known or later developed. However, it will be appreciated that arrangements described herein can be used in connection with non-vehicular applications and/or non-seat applications.

In one or more arrangements, a plurality of actuators 100 can be operatively positioned relative to one or more surfaces or portions of the seat. The one or more surfaces can be a surface of the back portion, the seat portion, a bolster of the back portion, a bolster of the seat portion, a headrest, an arm rest, or any combination or subset thereof. When actuated, one or more of the actuators 100 can cause the surfaces or portions of the seat to morph into a different configuration and/or one or more of the actuators 100 can provide a physical sensation to an occupant of the seat. Likewise, the movement (e.g., rotation, pivoting, etc.) of the massaging element(s) 155 can provide a physical sensation to an occupant of the seat.

In arrangements with a plurality of actuators, the plurality of actuators can be substantially identical to each other. Alternatively, one or more of the actuators can be different from the other actuators in one or more respects, such as size, shape, configuration, actuation effect, etc. The plurality of actuators can be arranged and/or distributed in any suitable manner. In some instances, the plurality of actuations can be arranged in rows and columns. In some instances, the plurality of actuators can be arranged in a plurality of discrete areas, which may or may not be spaced apart.

It will be appreciated that arrangements described herein can provide numerous benefits, including one or more of the benefits mentioned herein. For example, arrangements described herein can provide an enhanced experience for a seat occupant. Arrangements described herein can provide an enhanced massaging effect. When used in connection with a seat, arrangements described herein can provide a pushing effect to a seat occupant. In addition, arrangements described herein can provide a massaging sensation by way of the one or more massaging elements.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The term “or” is intended to mean an inclusive “or” rather than an exclusive “or.” The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC). As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

What is claimed is:

1. An actuator, comprising:
an outer body member;
a push structure operatively connected to the outer body member; and
a massaging element movably connected to the push structure,
when activated, the actuator is configured to morph into an activated configuration in which a dimension of the actuator increases and such that a position of the push structure changes.

2. The actuator of claim 1, further including one or more contracting members, when an activation input is provided to the one or more contracting members, the one or more contracting members contract, thereby causing the actuator to morph into an activated configuration.

3. The actuator of claim 2, wherein the one or more contracting members are one or more shape memory material members.

4. The actuator of claim 2, further including one or more processors operatively connected to the one or more contracting members, whereby the one or more processors are configured to selectively activate the one or more contracting members, thereby causing the actuator to morph into the activated configuration.

5. The actuator of claim 4, further including one or more power sources operatively connected to supply electrical energy to the one or more contracting members, wherein the one or more processors are operatively connected to the one or more power sources, wherein the one or more processors are configured to selectively control a supply of electrical energy to the one or more contracting members.

6. The actuator of claim 4, further including one or more sensors configured to acquire sensor data, wherein the one or more sensors being operatively connected to the one or more processors, and wherein the one or more processors are configured to selectively cause the actuator to be activated based on sensor data acquired by the one or more sensors.

7. The actuator of claim 4, further including one or more user input interfaces, wherein the one or more user input interfaces are operatively connected to the one or more processors, and wherein the one or more processors are configured to selectively cause the actuator to be activated in response to an input provided on the one or more user input interfaces.

8. The actuator of claim 1, wherein, when the massaging element comes into operative contact with an object, the massaging element moves from a neutral position to a moved position.

9. The actuator of claim 8, wherein, when moving from the neutral position to the moved position, the massaging element rotates or pivots.

10. The actuator of claim 8, further including a biasing element operatively connected to the massaging element, wherein the biasing element biases the massaging element toward the neutral position.

11. The actuator of claim 1, wherein the massaging element is partially embedded in the push structure, and wherein a portion of the massaging element extends beyond an engaging surface of the push structure.

12. The actuator of claim 1, wherein the massaging element is movably connected to a post, and wherein the post extends from an engaging surface of the push structure.

13. The actuator of claim 12, wherein the massaging element is pivotably connected to the post.

14. The actuator of claim 1, wherein the massaging element includes a surface for engaging an object, and wherein the surface is curved.

15. The actuator of claim 1, wherein the massaging element is located proximate to an edge of the push structure.

16. A method for an actuator, the actuator including an outer body member, the actuator including a push structure operatively connected to the outer body member, the actuator including a massaging element movably connected to the push structure, the method comprising:
causing the actuator to morph into an activated configuration in which a dimension of the actuator increases and such that a position of the push structure changes; and
imparting a load on the massaging element to cause a movement of the massaging element, whereby the massaging element moves from a neutral position to a moved position.

17. The method of claim 16, further including:
biasing the massaging element to the neutral position, whereby, when a load is no longer imparted on the massaging element, the massaging element returns to the neutral position.

18. The method of claim 16, wherein the actuator includes one or more contracting members, and wherein causing the actuator to morph into an activated configuration includes providing an activation input to the one or more contracting members to cause the one or more contracting members to contract, thereby causing the actuator to morph into an activated configuration.

19. The method of claim 16, wherein causing the actuator to morph into an activated configuration is performed based on a user input or sensor data.

20. The method of claim 16, imparting a load on the massaging element includes bringing the massaging element into operative contact with an object.
